(19) United States
(12) Patent Application Publication
(10) Pub. No.: US 2019/0263440 A1
(43) Pub. Date: Aug. 29, 2019

(54) CLIMATE CONTROLLED STEERING WHEEL

(71) Applicant: Key Safety Systems, Inc., Sterling Heights, MI (US)

(72) Inventor: Byron Spencer, Bloomfield, MI (US)

(21) Appl. No.: 16/344,859

(22) PCT Filed: Sep. 12, 2017
(86) PCT No.: PCT/US17/51063

§ 371 Date: Apr. 25, 2019

Related U.S. Application Data
(60) Provisional application No. 62/395,844, filed on Sep. 16, 2016.

(51) Int. Cl. B62D 1/06; B60H 1/00

(52) U.S. Cl. CPC B62D 1/065; B60H 1/00292; B60H 2001/0015; B60H 2001/00092; B60H 1/00564

(57) ABSTRACT

A climate controlled steering device (10) for a vehicle including a hand control assembly (12) with air ducting (34), the climate controlled steering device (10) including a clock spring assembly (18) combined with a plenum (36) to guide HVAC air into the hand control assembly ducting (34) at a plurality of angular positions of the hand control assembly (12).

### BACKGROUND AND SUMMARY OF THE INVENTION

The claimed invention relates to air cooled and heated steering wheels for vehicles.

Heated and cooled steering wheels are generally known, see for example the following published patents and patent applications as cited by publication number: CN 2014432716; EP 2753530 A1; U.S. Pat. Nos. 4,679,730; 4,640,340; 6,481,312; 6,007,420; 6,862,807; 6,298,750; 7,614,682; 7,908,941; 8,993,929; 9,033,366; US 20040168540; US 20060121843; US 20090007721; US 20090114368; US 20130055849; US 20140090513; and US 20150197135.

What is needed is an improved climate controlled steering wheel. As disclosed herein there is provided a steering device for a vehicle wherein the hand grip or grips can be heated and cooled with air. The steering device may be a steering wheel for a motor vehicle, such as an automobile or truck. Heated or cooled air may be provided by an air handling system. The air handling system may include the HVAC system of the vehicle.

In certain embodiments the devices solve problems of ducting sufficient HVAC air from a vehicle HVAC system past the column assembly around a clock spring assembly and into a steering wheel assembly to enhance temperature change and/or temperature rate change and/or ultimate temperature. In various other embodiments a clock spring assembly is combined with a plenum to guide HVAC air into the hand control assembly over a plurality of or at all of the angular, operating positions of the hand control assembly.

As shown in various embodiments, exemplary climate controlled steering assemblies include one or more of the following: a rim assembly; a hub assembly; a plurality of spokes; a clock spring assembly; a plenum assembly; an air flow path; a column assembly and an HVAC assembly. The climate control system may include an air flow path routed past the column assembly, through the plenum, around the clock spring, through at least one of a plurality of spokes and into the rim assembly. The air flow path may be split and routed into the rim assembly via a plurality of entry points or angles to increase the combined cross-sectional area of air flow. Increasing a combined cross-sectional area of air flow through the hand control assembly can increase total airflow volume through the system and/or heat exchange rate in the hand grips.

Also contemplated in this disclosure is a steering device with a climate controlled hand grip assembly that uses air from a vehicle's HVAC system. The HVAC system may be connected to ducting routed to and through the hand grip(s). The ducting may have an air flow path with a cross-sectional area sufficient to move heated and cooled air from a vehicle HVAC through the hand grip(s) in an amount sufficient to generate a temperature change at the surface of the hand controls of 15 degrees or more for heating and 5 degrees or more for cooling.

Many other objects and purposes of the invention will be clear from the following detailed description of the drawings.

### BRIEF DESCRIPTION OF THE DRAWINGS

FIG. 1 is a cross-sectional, perspective view of a climate controlled steering assembly;

FIG. 2 is a perspective view of a climate controlled steering assembly with a plenum assembly;

FIG. 3 is a perspective view of a climate controlled steering assembly;

FIG. 4 is a perspective view of a part of an air passage;

FIG. 5 is an exploded view of a part of the air passage shown in FIG. 5;

FIG. 6 is a perspective view of a steering wheel module;

FIG. 7 is a cross-sectional outline of an air path and the ducting network for a climate controlled steering assembly as in FIG. 1; and

FIG. 8 is a graph of temperature/temperature change data versus time for a climate controlled steering wheel rim assembly.

### DETAILED DESCRIPTION OF THE DRAWINGS

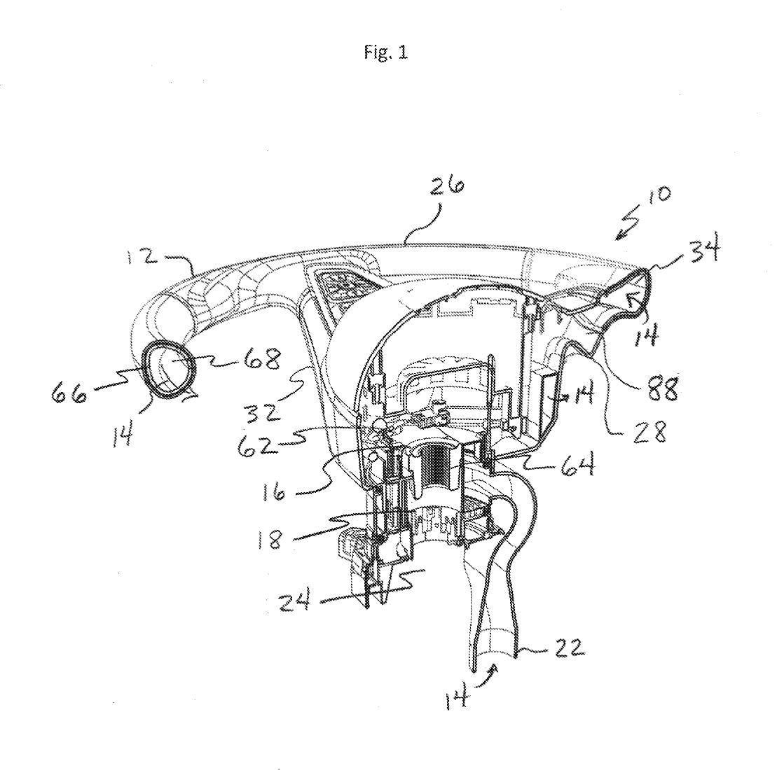

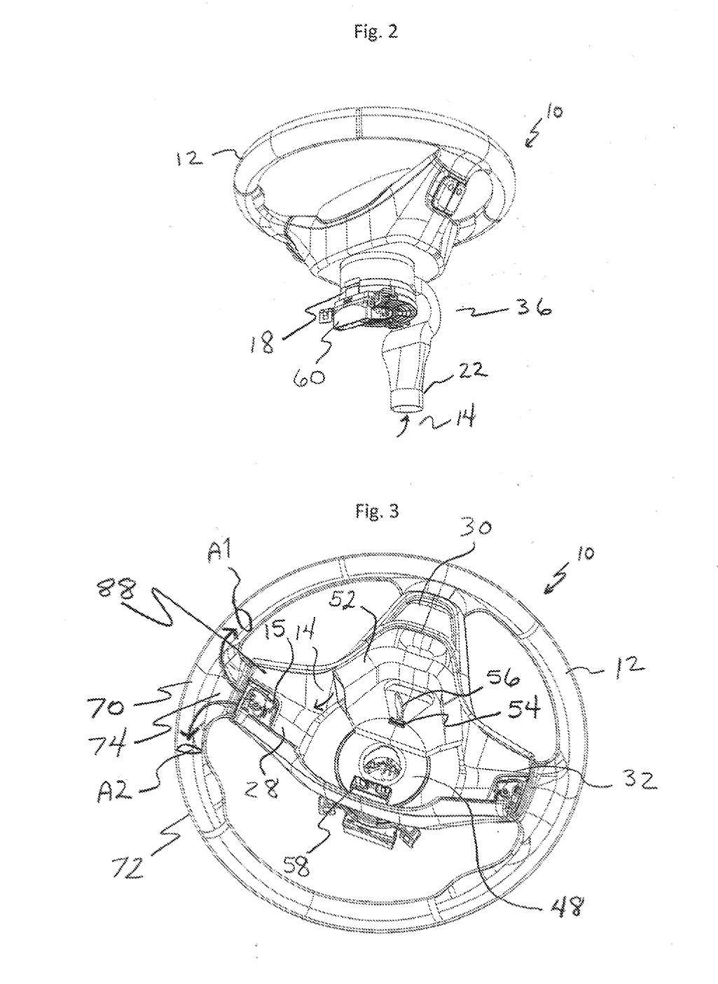

Referring now to FIGS. 1-3, shown generally therein at 10 is a steering device with a climate controlled hand control assembly 12 with a hand grip(s) 72. The steering device 10 has an air flow path 14 through the hand control assembly 12 and is ultimately connected to an HVAC system of a vehicle (not shown).

The steering devices described in the specification may include one or more of the following: a hub assembly; a column assembly; a clock spring assembly; ducting or a ducting network, an air flow path, and an HVAC system.

As shown, the hand control assembly 12 includes a rim 26. The rim 26 has an air flow path 14 and an outer surface 66. The air flow path of the rim may be provided by any suitable means. As shown the air flow path 14 is provided by ducting 34 within the rim 26. The ducting 34 is in fluid communication with the air flow path 14 disposed in one or more spokes 28, 30, 32. The air flow path of the hand control assembly may be provided by a hollow rim. As shown in FIG. 3 the hollow rim may be formed by with clam shell design or shape (shown in part). A clam shell shape may have concave interior walls 70 that meet to form a hollow interior. The clam shell design includes a plurality of walls, but may be formed by two halves joined together.

The rim 26 is attached to the one or more spokes 28, 30, 32 which in turn are connected to a hub assembly 16. The hub assembly 16 may have one or more armatures 62. The armature(s) may be used to support the hand control assembly 12. A spoke housing may at least partially surround each armature to form part of a spoke. As shown the one or more armature(s) 62 connect the rim 26 to a hub attachment means 64 and provide structural support. The attachment means 64 may include a splined, column shaft key.

The climate controlled steering assembly preferably includes a plenum. A plenum is a device that can capture air from one or more air ducts and distribute the air downstream. The plenum may be a single component or multi-component device with at least one air infeed opening and at least one air flow exit opening. The plenum may have an upper plenum portion that is upstream the air flow and a lower plenum portion that is more downstream the air flow. The plenum may be shaped and sized to reduce or minimize pressure drop of air downstream. The plenum may be shaped to guide the air flow path around the hub assembly. The plenum may be shaped with a cross-sectional air flow area that is greater than or equal to the combined cross-sectional air flow area of the air path through the hand control assembly. If the hand control assembly includes a rim attached to a hub assembly with spokes, air may enter the rim by way of the one or more spokes and travel in multiple directions around the rim to increase the combined cross-sectional air flow area of the air path through the hand control assembly. Each direction or separate air stream will have a cross-sectional area A1, A2 . . . which when add together (A1+A2+. . . ) make a combined cross-sectional air flow area of the air path.

In one embodiment the plenum assembly includes an air plenum chamber defined by an annular duct disposed around the column shaft. A wall or section of the plenum may be rotatable and can move angularly with the hub assembly and the steering wheel. When present the movable portion of the plenum may also move angularly with the column shaft. Another wall or portion of the plenum may remain stationary or relative to the column assembly. The fixed and movable portions may be inner and outer walls, upper and lower walls, etc.

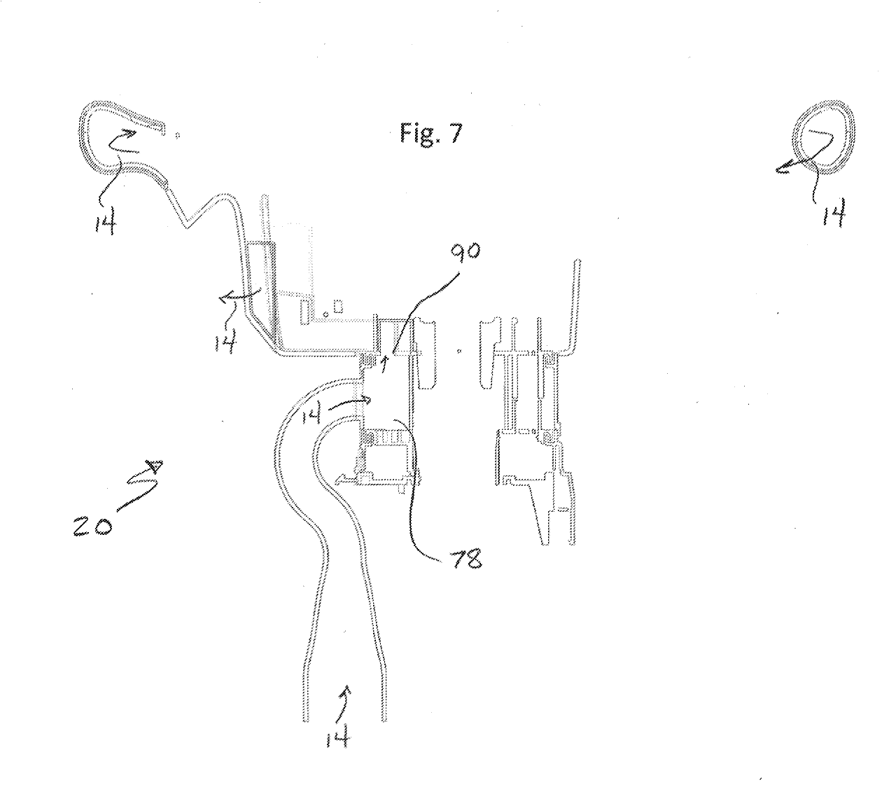

FIG. 7 depicts a cross-sectional outline of an air flow path 14 for a climate controlled steering assembly of a device as shown in FIG. 1. The assembly shows a ducting network 20 or ducting which provides at least part of the air path 14. An air duct (not shown) from an output side of an HVAC system can be connected to the plenum. The plenum has a plenum chamber 78. The plenum chamber is closed by an end wall of the clock spring on one end and closed by a parallel wall of the clock spring at another end. One wall of the clock spring has a segment shaped exit port 90. A duct in the hand control assembly has a matching segment shaped inlet port into which air can enter and flow axially toward the driver. Immediately on entry into the hand control assembly the air takes ˜90 degree bends to flow in two directions radially outward away from the axis. At this point the duct is bifurcated with the left hand branch taking the longer path from 9 to 6 to 3 o'clock and the right hand branch taking a more direct route toward 3 o'clock. The two branches are used to increase the air passage total cross-sectional area at the location of the 90 degree bends to provide a sufficient air flow. In this example the air flow volume can be doubled. The two branches of the duct broadly follow interior contours of the back-cover and join together at the 3 o'clock position to form a single exit into the steering wheel spoke baffle. The spokes may include one or more baffles to block or channel air. The spoke baffle may close off one spoke so that air passing through the duct entrance will flow radially outward along the spoke and around the steering wheel rim. Air may exit through one or more vents.

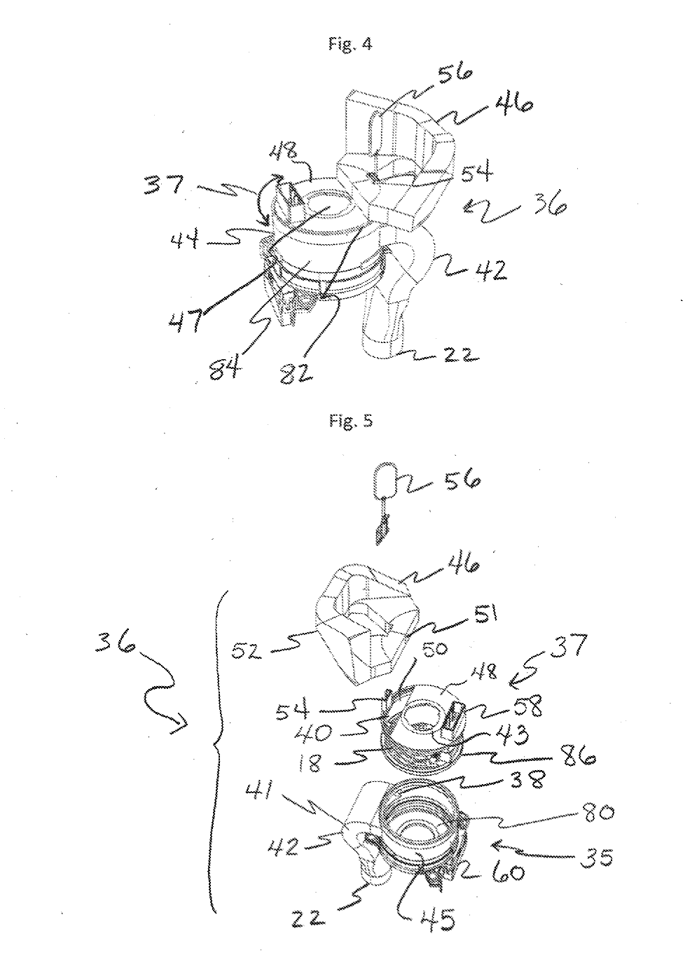

Referring now to FIGS. 4 and 5, shown therein is a plenum assembly 36 formed of multiple components or regions. The plenum assembly 36 may include a fixed portion 35 and a rotatable portion 37. The rotatable portion 37 can move with the hand control assembly 12. The rotatable portion 37 can guide HVAC air into the hand control assembly at a plurality of or even all of the angular operating positions of the hand control assembly 12.

As shown the plenum assembly 36 has an upstream plenum 42, a central plenum 44 and a downstream plenum 46. Component naming in this case is based on air flow with “upstream” being closer in flow proximity to the HVAC system. The upstream plenum 42 has an HVAC connection 22. The HVAC connection 22 may have a generally cylindrical cross-section. From the HVAC connection the plenum cross-sectional area changes aspect ratio as it travels towards the central plenum 44. The aspect ratio of the upper housing may narrow in one dimension while expanding in another dimension as the housing progresses towards the central plenum. As shown the upstream plenum 42 gently curves into the central plenum housing by way of an air path redirector 41 or redirecting ducting. A gently curved redirector is one that is curved in a radius other than a sharp 90 degree corner. The width of the housing may be greater than the height. The upstream plenum 42 may direct climate controlled air into a central plenum with little (less than 10%) to no pressure drop. The central plenum 44 has at least one infeed opening 38 and at least one out feed opening 40. The central plenum may be open at a side to the upstream plenum. The central plenum 44 has inner 43 and outer housings 45. The central plenum is shown with generally cylindrical housings. The housings 43, 45 may be annular with a void 47 through the middle. The housings 43, 45 may be concentric. The void 47 through the middle of the plenum 36 may be used to pass a column shaft (not shown) through. The central plenum 44 may surround the column shaft at least partially or may surround the column shaft completely. The central plenum 44 has a cover 48 with an air path opening 50 that leads to the downstream plenum 46.

The downstream plenum 46 may be a duct. The downstream plenum may be fixed to the cover 48 to direct air flow from one directional plane to another. The first directional plane may be generally perpendicular to the second plane. The downstream plenum 46 may include a hood 52 over the air path opening 50. The downstream plenum 46 may also have an air path opening 51 that matches the air path opening 50 of the central plenum 44. In one direction the hood 52 may expand in a downstream direction. The hood 52 may taper to a closed wall section in another direction. The downstream plenum 46 may be used to collect air from the upstream plenum and redirect the air to the inside of the steering assembly or to one or more spokes. As shown the hood 52 splits the air path, recombines it in a progressively broadening channel that collects the air flowing radially into it while maintaining a generally constant cross section area to the flow stream.

The steering device may have a clock spring that is combined with the plenum. The clock spring and plenum may share walls that form the housing of the plenum chamber. The clock spring assembly may fit inside the plenum assembly outer wall and form the inner wall of the plenum. The clock spring may rotate within the plenum fixed outer housing. The plenum may have one or more portions that rotate with the clock spring.

As shown in FIGS. 4 and 5 a plurality of walls form at least part of the plenum assembly 36. The walls are shared with the clock spring 18. In the embodiment shown a cover 48 of the plenum is shared with the cover of the clock spring 18. The cover 48 is rotatable. The cover 48 has an air passage 50 open to the lower plenum 46. The cover 48 has one or more electrical connectors 58 for steering wheel controls, vehicle components or vehicle accessories. The cover 48 is shown with a clock spring lock key guide 54. The plenum 36 has a base 80 that supports the base of the clock spring 86. The base 86 of the clock spring 18 may rotate upon the plenum base 80. The plenum base 80 and clock spring base 86 may be sealed against air leaks. The plenum base 80 may be fixed in relation to a column assembly. The plenum base 80 may have one or more electrical connectors 60. The clock spring assembly may have more than one wall that rotates about the plenum housing. The clock-spring may be displaced axially downward away from the hand control assembly by an amount needed by the plenum air flow chamber 78. The clock spring connections may be extended axially upward through the space of the plenum air flow chamber 78 to project into the steering wheel housing where the steering wheel wiring harness may be connected.

If a clock spring assembly is present, rotatable portions of the clock spring assembly may be temporality locked. Temporarily locking rotation allows the steering wheel module to be fixed on a column assembly in a predetermined position and then released. Temporary locking may be provided by a key. The key may be removable. In practice and where the clock spring is combined with the plenum removing the key after vehicle installation of the steering assembly allows the clock spring and a portion of the plenum to rotate with the steering wheel hand controls. As best seen in FIGS. 3, 4 and 5 a clock spring lock key 56 fits into a clock spring lock key guide 54. As shown the lower plenum 46 has a passage for the clock spring lock key guide 54 to pass through. The key 56 is temporarily seated in the key guide 54. The key 56 provides an angular lock to temporarily lock the rotation of the clock spring and the associated plenum portion prior to steering wheel installation. Removing the key allows the clock spring and associated plenum portion to rotate.

As shown in FIGS. 1 and 3 the steering assembly 10 may include an inner chamber 88 formed by a steering wheel housing surrounding the hub assembly. The inner chamber 88 of the steering assembly may be open to air flow from the HVAC system and/or the plenum. The inner chamber may be in fluid communication with the one or more air passages in the hand grips. A duct(s) and a baffle(s) can guide HVAC air from the steering wheel interior into a spoke and thence into a hollow rim.

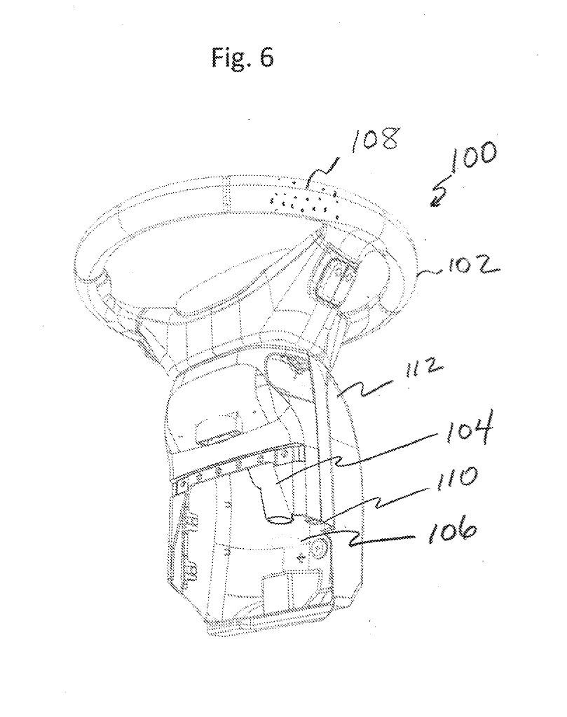

The steering device may be provided as a module with the steering components and the air ducting combined in a single unit ready for installation into a vehicle. As shown in FIG. 6 the module 100 includes steering components 102 coupled with a plenum assembly 104 connected to air ducting all the way to an HVAC connection 106. As shown air can travel from the HVAC connection, through the hand controls and out a vent 110 in the steering wheel cover 112 or through openings 108 in the hand controls.

In an exemplary steering wheel as exemplified in FIG. 1, the device includes: a rim 26, the rim 26 including air ducting 34 and a rim surface 66; a column assembly 24; a hub assembly 16 with a bearing for connecting to the column assembly 24; a plurality of spokes 28, 32 connecting the rim 26 to the hub assembly 16; a clock spring assembly 18; a plenum 36 combined with the clock spring assembly 18, the plenum 36 including a fixed duct 84 that is fixed relative to the column assembly 24 and a rotatable housing portion 82 that moves relative to the fixed duct 84 and in proportion to the movement of the rim 26; and an air flow path 14 open to a vehicle HVAC system through which HVAC air can pass, the air flow path 14 passing through the plenum fixed duct 84, the rotatable housing portion 82, through at least one of the plurality of spokes 28, 30, 32, the air flow path 14 split and routed in a plurality of directions around the rim 26 and vented to a vehicle interior. In operation spent air may be vented to the vehicle interior through any suitable means including one or more spokes and/or through the steering wheel back-cover and/or through openings 108 in the hand grips.

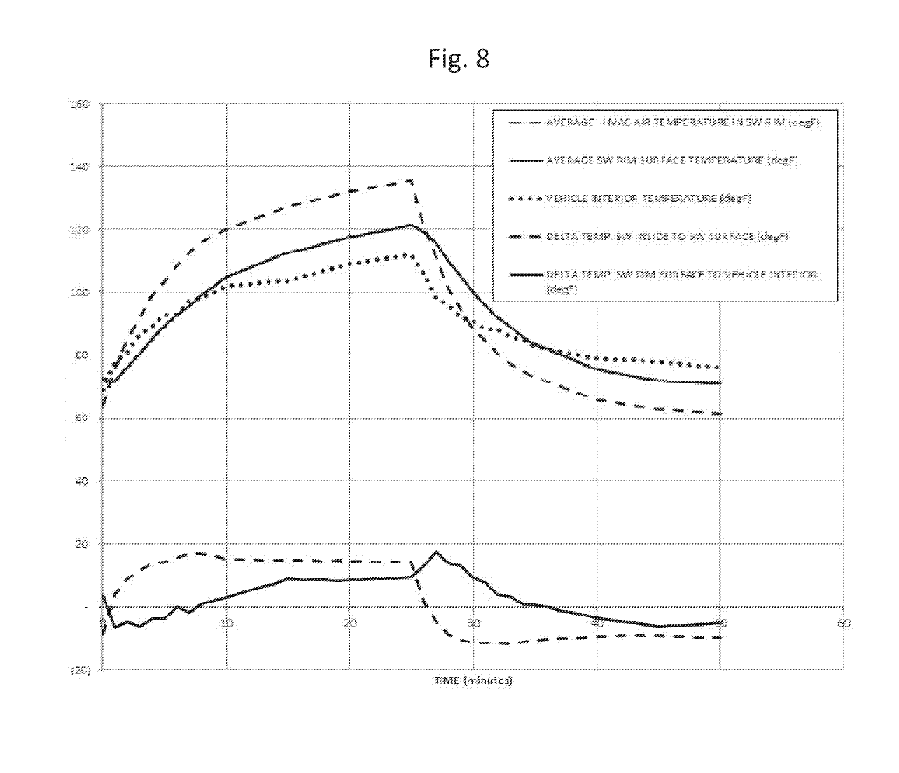

Example: A steering wheel rim made from aluminum tube was wrapped with leather and fitted with ducting as described above. The steering wheel rim was installed in a typical vehicle and the HVAC system of the vehicle was connected to the steering wheel ducting. As provided in this example the vehicle was a minivan. The HVAC was turned on. Steering wheel temperature, vehicle interior temperature, and HVAC air temperature measurements were taken over time as the system was set to heat and to cool. The results were plotted as shown in FIG. 8 along with the delta temperature between the steering wheel inside and the steering wheel surface; and the delta temperature between the steering wheel surface and the vehicle interior. As shown in FIG. 8, the leather was favorably hotter or colder than the interior air after 8 minutes. As provided in this example the temperature peaked in 15 minutes at about 8 deg F. during heating and in 15 minutes at about −6 deg F. during cooling. It was found that the temperature of the leather surface of a steering wheel can be perceptibly improved over the vehicle interior air for both heating and cooling in less than 10 minutes.

Throughout the drawings and specification like numerals refer to similar components. In the specification features of specific embodiments can be selected in isolation from each other and combined with other embodiments even if only described in relation to a specific embodiment. As can be appreciated by the written description and drawings there is an ample teaching and suggestion of how to combine generally discussed features with alternative embodiments disclosed in the specification.

While the invention has been illustrated in the foregoing description, the same is to be considered as illustrative and not restrictive in character. Therefore, it should be understood that only the preferred embodiments have been shown and described fully and that all changes and modifications that come within the scope of the claimed invention are desired to be protected.

Many changes and modifications in the above-described embodiment of the invention can, of course, be carried out without departing from the scope thereof. Accordingly, that scope is intended to be limited only by the scope of the appended claims.

1. A climate controlled steering device for a vehicle comprising:
a hand control assembly (12) including hand grips (72), the hand grips (72) including air ducting (34);
a hub assembly (16) supporting the hand control assembly (12);
a clock spring assembly (18) supported by the hub assembly (16);
an HVAC connection (22);
a plenum (36) coupled with the HVAC connection (22); and
wherein the clock spring assembly (18) is combined with the plenum (36) forming a path for HVAC air into the hand control assembly (12) over a plurality of angular positions of the hand control assembly (12).

2. The climate controlled steering device of claim 1 wherein the clock spring assembly (18) and the plenum (36) share a rotatable portion (37) that moves with the hand control assembly (12).

3. The climate controlled steering device of claim 1 wherein the hand control assembly (12) includes one or more spokes (28) and a rim (26), the one or more spokes (28) connecting the rim (26) to the hub assembly (18), the one or more spokes (26) having air ducting (15) in communication with the plenum (36) forming part of an air flow path (14); the one or more spokes (28) splitting the air flow path (14) into two or more air streams (74) that enter the rim (26) and travel in different directions.

4. The climate controlled steering device of claim 3 further including a cover (112) shrouding the hub assembly (16), a vent (110) disposed through the cover (112) and wherein the one or more spokes (28) have an air flow path (14) coupled with the air ducting (34) in the rim (26) that leads out the vent (110).

5. The climate controlled steering device of claim 1 wherein the device includes a cover (112) with a vent (110) that is open to a vehicle interior and is in fluid communication with the air ducting (34) in the hand control assembly (12).

6. The climate controlled steering device of claim 1 wherein the hand control assembly (12) includes openings (108) connecting an air path 14 from the air ducting (34) in the hand control assembly (12) to a vehicle interior.

7. The climate controlled steering device of claim 1 wherein the plenum (36) has a rotatable housing portion (82) shared with the clock spring (18) and includes one or more electrical connectors (58).

8. The climate controlled steering device of claim 1 wherein a plurality of angular positions of the hand control assembly (12) is all of the angular operating positions of the hand control assembly (12).

9. The climate controlled steering device of claim 1 wherein the plenum (36) includes an upstream plenum (42), a central plenum (44), and a downstream plenum (46), the upstream plenum (42) is fixed in position relative to a column assembly (24), the central plenum (44) includes an annular housing (45) that surrounds the column assembly (24) and is disposed between the upstream plenum (42) and the downstream plenum (46), the downstream plenum (42) being an air duct that changes position in proportion to an angular position change in the hand control assembly (12).

10. A steering assembly for a vehicle comprising:
a hub assembly (16);
a hand control assembly (12) supported by the hub assembly (16), the hand control assembly (12) having an external surface (66);
an air flow path (14) open to a vehicle HVAC system and routed through the hand control assembly (12); the air flow path (14) includes a plenum (36), an air splitter, the air splitter separating the air flow path (14) into two or more air streams (74) that enter and are routed through the hand control assembly (12), the air flow path (14) having a cross-sectional area at all times through and after the plenum (36) being equal to or greater than the minimum internal cross-sectional area of the combined two or more air streams (A1, A2) of the hand control assembly (12).

11. The steering assembly of claim 10 wherein the hand control assembly (12) includes a hollow rim (26), and wherein the air flow path (14) that is split into two or more air streams (74) is split into two air streams (74) around the rim (26) in different directions, the two air streams (74) providing a combined air flow path cross-sectional area (A1, A2) around the rim, the air flow path (14) having a cross-sectional area at all times through and after the plenum that is equal to or greater than the minimum internal combined cross-sectional area of the two air streams.

12. The steering assembly of claim 10 wherein the air flow path (14) is vented through a steering wheel cover (112) to a vehicle interior.

13. The steering assembly of claim 10 wherein the air flow path (14) is routed through the hand control assembly (12) and has a cross-sectional area sized in an amount sufficient to move a volume of heated and cooled air through the internal ducting (34) of the hand control assembly (12) which is sufficient to generate a temperature change at the external surface (66) of the hand control assembly (12) of 15 degrees or more for heating and 5 degrees or more for cooling.

14. The steering assembly of claim 10 wherein a clock spring assembly (18) is combined with the plenum (36) to guide HVAC air into the hand control assembly (12) at all angular operating positions of the hand control assembly (12).

15. A climate controlled steering wheel for a vehicle comprising:
a hand grip (72), the hand grip (72) having an external surface (66) and air ducting (34) in heat transfer contact with the external surface (66); and
an air flow path (14) from an HVAC system through the air ducting (34), the air ducting (34) having a cross-sectional area sized in an amount sufficient to move heated and cooled air through the air ducting in an amount sufficient to generate a temperature change at the external surface (66) of the hand grip (72) of 15 degrees or more for heating and 5 degrees or more for cooling in 10 minutes or less.

16. The climate controlled steering wheel of claim 16 wherein the air flow path (14) is split into two or more air streams (74) that are routed in a plurality of directions around the hand grip (72).

17. The climate controlled steering wheel of claim 16 wherein the air flow path (14) upstream from the hand control assembly (12) has at all times a cross-sectional area equal to or greater than the combined minimum internal cross-sectional area (A1, A2) of the hand grip (72).

18. The climate controlled steering wheel of claim 15 wherein the air flow path (14) is routed through a plenum (36) combined with a clock spring assembly (18), the combination including a chamber (35) that is fixed in relation to a steering wheel column assembly (24) and a movable portion (37) that moves with the hand grip (72).

19. The climate controlled steering wheel of claim 15 further including one or more spokes (28) and a hub assembly (16), wherein the hand grip (72) includes a rim (26) connected to the hub assembly (16) by the one or more spokes (28), the one or more spokes (28) having air ducting that is split into at least two air streams (74) that travel in different directions around the rim (26).

20. The climate controlled steering wheel of claim 19 wherein the air flow path (14) is routed through a plenum (36) combined with a clock spring assembly (18), past a column assembly (24), around the hub assembly (16), through the one or more spokes (28), and around the rim (26).
